(19) United States
(12) Patent Application Publication
(10) Pub. No.: US 2022/0058606 A1
(43) Pub. Date: Feb. 24, 2022

(54) Keypad Overlay for Credit Card Machines

(71) Applicant: Sales Data, Inc., Hutchinson, KS (US)

(72) Inventor: Jerry Boone, Hutchinson, KS (US)

(21) Appl. No.: 17/407,726

(22) Filed: Aug. 20, 2021

Related U.S. Application Data
(63) Continuation-in-part of application No. 29/751,581, filed on Sep. 22, 2020.
(60) Provisional application No. 63/068,027, filed on Aug. 20, 2020.

(51) Int. Cl. G06Q 20/20; G06F 3/02; H01H 13/70; H01H 13/14; G09B 21/00

(52) U.S. Cl. CPC G06Q 20/20; G06F 3/0202; G09B 21/003; H01H 13/14; H01H 13/70

(57) ABSTRACT

A keypad overlay for credit card machines includes a main panel, a lateral wall, a connector wall, a plurality of button receiving features, a first attachment hole, and a second attachment hole. The connector wall and the lateral wall are perimetrically positioned around the main panel. The connector wall is terminally connected to the main panel. The lateral wall is terminally connected to the main panel. The plurality of button receiving features is integrated onto the main panel. The first attachment hole and the second attachment hole are oppositely positioned of each other along the connector wall. The first attachment hole traverses through the connector wall. The second attachment hole traverses through the connector wall.

The current application claims a priority to the U.S. Provisional Patent application Ser. No. 63/068,027 filed on Aug. 20, 2020.

The current application is also a continuation-in-part (CIP) application of the U.S. design application Ser. No. 29/751,581 filed on Sep. 22, 2020.

### FIELD OF THE INVENTION

The present invention relates to keypad covers. More specifically, the present invention is a keypad overlay that protects the keypad of a VeriFone MX915 or MX925.

### BACKGROUND OF THE INVENTION

When it comes to the retail industry, the usage of VeriFone products is utilized in the assistance of payment. More specifically, the VeriFone MX915 or MX925 is utilized almost everywhere as it provides customers a seamless payment experience with a variety of payment methods. An issue arises when the countless numbers of public VeriFone MX915 or MX925 are used continuously as cleaning and sanitation is required for the safety of the general public. Especially in times like year 2020, the Covid-19 pandemic has created a great deal out of cleaning and sanitization of publicly used equipment to ensure the safety of the general public. The Covid-19 pandemic has created an increase level of cleaning that has led to the increased failure of the VeriFone MX915 or MX925. The personal identification number (PIN) entry keypad is one aspect of the unit where sanitization liquid can enter the device and potentially destroying the device from further use. In addition, the liquid can potentially damage the underlying button contacts if sprayed directly on the keypad area. Furthermore, accidental spilled drinks or liquids have also shortened the intended life expectancy of these devices as well.

An objective of the present invention is to provide a protective cover for the keypads of existing VeriFone MX915 or MX925. The present invention is a vacuum-formed plastic device that will cover the keypad area of VeriFone MX915 or MX925. In addition, the present invention provides a protective cover that allow the user to clean the keypad swiftly and efficiently without the worry of potentially damaging the device.

### BRIEF DESCRIPTION OF THE DRAWINGS

FIG. 1 is a perspective view of the present invention.

FIG. 2 is a top view of the present invention showing the edges of the main panel.

FIG. 3 is a side view of the present invention showing the opposite orientation of the connector wall and the lateral wall.

FIG. 4 is a top view of the present invention showing the plurality of button receiving features.

FIG. 5 is a top view of the present invention showing all of the braille identifications.

### DETAIL DESCRIPTIONS OF THE INVENTION

All illustrations of the drawings are for the purpose of describing selected versions of the present invention and are not intended to limit the scope of the present invention.

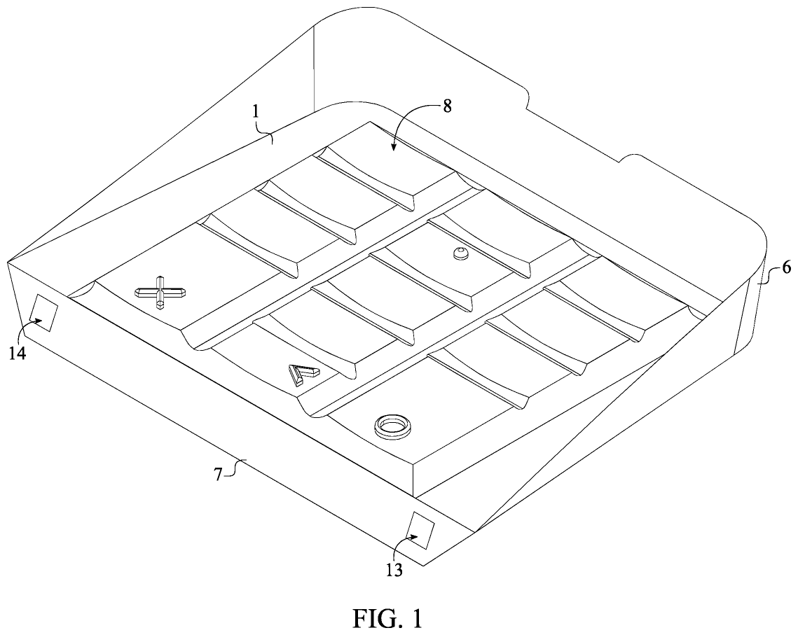

The present invention is a keypad overlay for credit card machines. More specifically, the present invention provides an exact match for a keypad of VeriFone MX915 or MX925. The present invention allows for swift and efficient cleaning of the keypad without the worry of damaging the device. The present invention comprises a main panel 1, a lateral wall 6, a connector wall 7, a plurality of button receiving features 8, a first attachment hole 13, and a second attachment hole 14 as shown in FIG. 1.

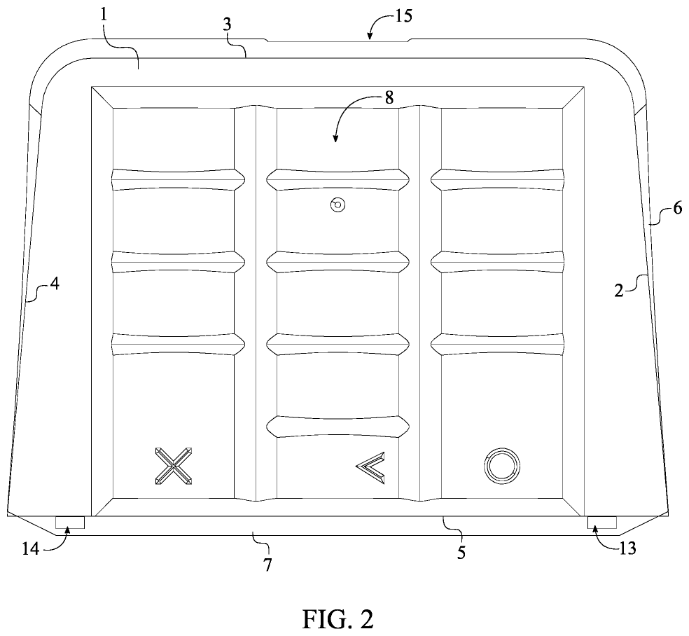

The main panel 1 functions as the surface area that covers the keypad of the VeriFone MX915 or MX925. In other words, the main panel 1 is designed to be placed on top of the keypad and align with each button of the keypad. As shown in FIG. 2, the main panel 1 comprising a left edge 2, a top edge 3, a right edge 4, and a bottom edge 5. More specifically, the left edge 2 and the right edge 4 are oppositely positioned of each other about the top edge 3. The left edge 2 being angularly positioned to the top edge 3. The right edge 4 is angularly positioned to the top edge 3. Preferably, the left edge 2 and the right edge 4 are particularly positioned to the top edge 3. The top edge 3 and the bottom edge 5 are positioned parallel to each other, wherein the bottom edge 5 is extended from the left edge 2 to the right edge 4.

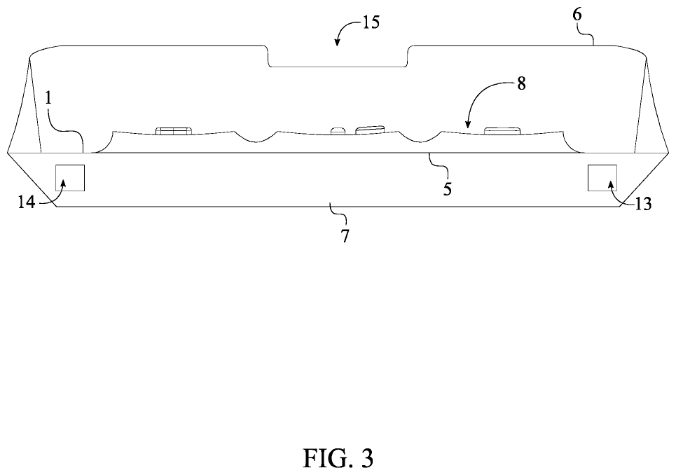

In reference to FIG. 3, the connector wall 7 and the lateral wall 6 are perimetrically positioned around the main panel 1, wherein the connector wall 7 and the lateral wall 6 are oriented opposite of each other about the main panel 1. More specifically, the connector wall 7 is terminally connected to the main panel 1 extends along three sides of the main panel 1. The lateral wall 6 is terminally connected to the main panel 1 and extended along one side of the of the main panel 1. As shown in FIG. 1, the lateral wall 6 is perimetrically connected to the left edge 2, the top edge 3, and the right edge 4 so that the present invention can be pressed laterally against a keypad wall of the VeriFone MX915 or MX925. The connector wall 7 is perimetrically connected to the bottom edge 5 so that the present invention can be laterally pressed against the bottom wall of the VeriFone MX915 or MX925, atop the card inserting opening of the VeriFone MX915 or MX925.

In reference to FIGS. 2-3, the present invention further comprises a locking cavity 15 that traverses into the lateral wall 6. More specifically, the locking cavity 15 is centrally positioned to the top edge 3, wherein the locking cavity 15 enables a privacy shield to be attached to the VeriFone MX915 or MX925. The locking cavity 15 does not use any additional adhesions during the attachment of the privacy shield and is an elongated hole. As a result, the locking cavity 15 allows the privacy shield to be clipped onto the keypad wall as the lateral wall 6 is compressed in between the privacy shield and the keypad wall.

In reference to FIGS. 2-3, the first attachment hole 13 traverses through the connector wall 7 thus allowing a first locking pin of the privacy shield to be engaged with the VeriFone MX915 or MX925 via the first attachment hole 13. More specifically, the first lower attachment hole is preferably formed into a square hole. The first attachment hole 13 is positioned adjacent to the left edge 2 and the bottom edge 5 of the main panel 1 and does not use any additional adhesions as the first locking pin of the privacy shield is inserted through. As a result, the privacy shield is able to press the connector wall 7 up against the bottom wall of the VeriFone MX915 or MX925 thus securing the present invention.

In reference to FIGS. 2-3, the second attachment hole 14 traverses through the connector wall 7 thus allowing a second locking pin of the privacy shield to be engaged with the VeriFone MX915 or MX925 via the second attachment hole 14. More specifically, the second lower attachment hole is preferably formed into a square hole. The second attachment hole 14 is positioned adjacent to the right edge 4 and the bottom edge 5 of the main panel 1 and does not use any additional adhesions as the second locking pin of the privacy shield is inserted through. As a result, the privacy shield is able to press the connector wall 7 up against the bottom wall of the VeriFone MX915 or MX925 thus securing the present invention.

As shown in FIG. 3, the first attachment hole 13 and the second attachment hole 14 are oppositely positioned of each other along the connector wall 7 so that the connector wall 7 can be secured to the bottom wall of the VeriFone MX915 or MX925 via two different attachment points. Example, the first attachment hole 13 allows the connector wall 7 to be attached about the left edge 2 and the second attachment hole 14 allows the connector wall 7 to be attached about the right edge 4.

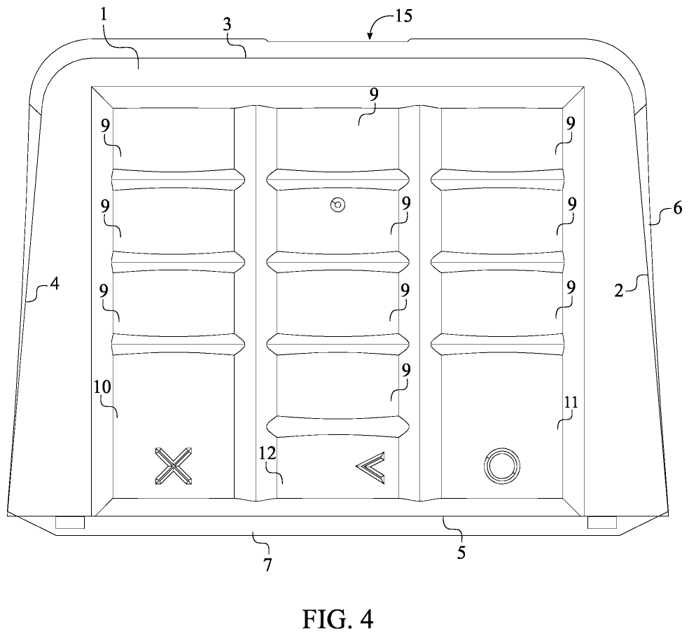

The plurality of button receiving features 8 is integrated onto the main panel 1 so that each individual button of the keypad can be protected from potential damage such as liquid leaking through the crevices of the buttons. The plurality of button receiving features 8 does not limit the quality of utility of the buttons of the keypad. In other words, the plurality of button receiving features 8 has no effect in altering the operations of the buttons of the keypad such as making them harder to press. In reference to FIG. 4, the plurality of button receiving features 8 comprises a set of numerical button receiving features 9, an accept button receiving feature 10, a decline button receiving feature 11, and a back button receiving feature 12. The set of numerical button receiving features 9 is positioned adjacent to the top edge 3 of the main panel 1 so that the numerical buttons of the keypad can be protected. Preferably, the set of numerical button receiving features 9 comprises ten separate features so that 0 button, 1 button, 2 button, 3 button, 4 button, 5 button, 6 button, 7 button, 8 button, and 9 button for the keypad of VeriFone MX915 or MX925 can be individually protected. The accept button receiving feature 10 is positioned adjacent to the bottom edge 5 and the right edge 4 of the main panel 1 in order to cover and protect an accept button of the keypad of VeriFone MX915 or MX925. The decline button receiving feature 11 is positioned adjacent to the bottom edge 5 and the left edge 2 of the main panel 1 in order to cover and protect a decline button for the keypad of VeriFone MX915 or MX925. The back button receiving feature 12 is positioned adjacent to the bottom edge 5. More specifically, the back button receiving feature 12 is positioned in between the accept button receiving feature 10 and the decline button receiving feature 11 so that a back button for the keypad of VeriFone MX915 or MX925 can be covered and protected.

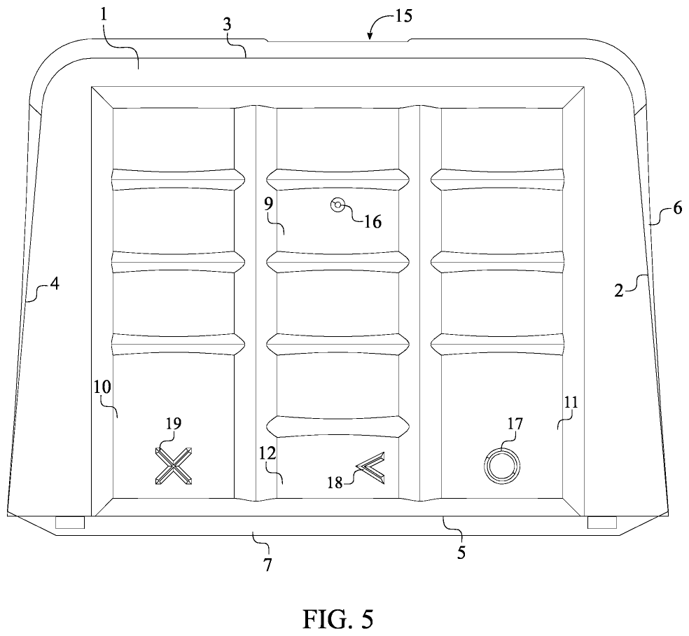

In reference to FIG. 5, the present invention further comprises a first braille identification 16 to assist the visually impaired users. The first braille identification 16 is integrated onto a specific feature of the set of numerical button receiving features 9, preferably as a dot imprint. More specifically, the first braille identification 16 is utilized by the visually impaired users to orientate and position themselves to the center of the keypad. In addition, the first braille identification 16 is positioned in such a way that the specific feature aligns with 5 button for the keypad when the present invention is placed secured.

In reference to FIG. 5, the present invention further comprises a second braille identification 17 to assist the visually impaired users. The second braille identification 17 is integrated onto the decline button receiving feature 11, preferably as a cross imprint. More specifically, the second braille identification 17 is utilized by the visually impaired users to identify the decline button of the keypad.

In reference to FIG. 5, the present invention further comprises a third braille identification 18 to assist the visually impaired users. The third braille identification 18 is integrated onto the back button receiving feature 12, preferably as a greater than imprint. More specifically, the third braille identification 18 is utilized by the visually impaired users to identify the back button of the keypad.

In reference to FIG. 5, the present invention further comprises a fourth braille identification 19 to assist the visually impaired users. The fourth braille identification 19 is integrated onto the accept button receiving feature 10, preferably as a circle imprint. More specifically, the fourth braille identification 19 is utilized by the visually impaired users to identify the accept button of the keypad.

The present invention is a vacuum-formed plastic device that covers the keypad of the VeriFone MX915 or MX925. The smooth forming around the plurality of button receiving features 8 assists tremendously in the sanitization and reduces the time needed to effectively clean the keypad. The design of the present invention allows swift and effective cleaning as the design is unique where the main panel 1 does not feature any sharp edges. In addition, in cases where sanitizing and cleaning the keypad requires the user to spray cleaning solution onto the keypad, the cleaning solution does not trickle through the crevices of the keypad which can potentially damage the device. The present invention is made of 100% clear transparent material. More specifically, 0.005 poly-ethylene terephthalate glycol (PETG) plastic material, which is extremely flexible, easy to heat, vacuum forms comfortable on the device, and bisphenol A (BPA) free.

The installation of the present invention does not require additional adhesive material. The installation of the present invention onto the keypad is accomplished by removing the rubber privacy shield, placing the present invention over the keypad with proper alignments with the locking cavity 15, the first lower attachment hole, and the second lower attachment hole with the VeriFone MX915 or MX925. After proper alignment, the privacy shield is then clasped back onto the VeriFone MX915 or MX925 thus resulting in the tight securement of the present invention. No adhesives are required and the privacy shield's factory retaining clips remain fully functional with no impairment of functionality. The present invention requires replacement over time as it is possible to get worn out over time. Depending on the volume of transaction and usage of the present invention, the keypad overlay is to be replaced monthly on average.

It is also important to note that the present invention has additional security measures. More specifically, payment card industry (PCI) compliance is achieved by giving complete transparency to the button area to allow inspection of the button operation. In a PIN number theft scenario, PIN numbers are “skimmed” by the covers designed to obscure or cover the buttons, thus hiding wires and circuits designed to record user input for theft of personal information. The present invention does not hide or obscure the original equipment manufacturer (OEM) interface.

Although the invention has been explained in relation to its preferred embodiment, it is to be understood that many other possible modifications and variations can be made without departing from the spirit and scope of the invention as hereinafter claimed.

What is claimed is:

1. A keypad overlay for credit card machines comprising:
a main panel;
a lateral wall;
a connector wall;
a plurality of button receiving features;
a first attachment hole;
a second attachment hole;
the connector wall and the lateral wall being perimetrically positioned around the main panel;
the connector wall being terminally connected to the main panel;
the lateral wall being terminally connected to the main panel;
the plurality of button receiving features being integrated onto the main panel;
the first attachment hole and the second attachment hole being oppositely positioned of each other along the connector wall;
the first attachment hole traversing through the connector wall; and
the second attachment hole traversing through the connector wall.

2. The keypad overlay for credit card machines as claimed in claim 1 comprising:
the main panel comprising a left edge, a top edge, and a right edge;
the left edge and the right edge being oppositely positioned of each other about the top edge;
the left edge being angularly positioned to the top edge;
the right edge being angularly positioned to the top edge; and
the lateral wall being perimetrically connected to the left edge, the top edge, and the right edge.

3. The keypad overlay for credit card machines as claimed in claim 2 comprising:
a locking cavity;
the locking cavity traverse into the lateral wall; and
the locking cavity being centrally positioned to the top edge, wherein the locking cavity enables a privacy shield to be attached to the credit card machine.

4. The keypad overlay for credit card machines as claimed in claim 1 comprising:
the main panel comprising a top edge and a bottom edge;
the top edge and the bottom edge being positioned parallel to each other; and
the connector wall being perimetrically connected to the bottom edge.

5. The keypad overlay for credit card machines as claimed in claim 1, wherein the connector wall and the lateral wall are oriented opposite of each other about the main panel.

6. The keypad overlay for credit card machines as claimed in claim 1 comprising:
the first attachment hole being positioned adjacent to a left edge and a bottom edge of the main panel, wherein the first attachment hole enables a privacy shield to be attached to the credit card machine.

7. The keypad overlay for credit card machines as claimed in claim 1 comprising:
the second attachment hole being positioned adjacent to a right edge and a bottom edge of the main panel, wherein the second attachment hole enables a privacy shield to be attached to the credit card machine.

8. The keypad overlay for credit card machines as claimed in claim 1 comprising:
the plurality of button receiving features comprising a set of numerical button receiving features, an accept button receiving feature, a decline button receiving feature, and a back button receiving feature;
the set of numerical button receiving features being positioned adjacent to a top edge of the main panel;
the accept button receiving feature being positioned adjacent to a bottom edge and a right edge of the main panel;
the decline button receiving feature being positioned adjacent to the bottom edge and a left edge of the main panel;
the back button receiving feature being positioned adjacent to the bottom edge; and
the back button receiving feature being positioned in between the accept button receiving feature and the decline button receiving feature.

9. The keypad overlay for credit card machines as claimed in claim 8 comprising:
a first braille identification; and
the first braille identification being integrated onto a specific feature of the set of numerical button receiving features.

10. The keypad overlay for credit card machines as claimed in claim 8 comprising:
a second braille identification; and
the second braille identification being integrated onto the decline button receiving feature.

11. The keypad overlay for credit card machines as claimed in claim 8 comprising:
a third braille identification; and
the third braille identification being integrated onto the back button receiving feature.

12. The keypad overlay for credit card machines as claimed in claim 8 comprising:
a fourth braille identification; and
the fourth braille identification being integrated onto the accept button receiving feature.
